(19) United States
(12) Patent Application Publication
(10) Pub. No.: US 2013/0016680 A1
(43) Pub. Date: Jan. 17, 2013

(54) Systems and Methods for Multi-User MIMO

(71) Applicants: Kelvin Kar-Kin Au, Ottawa (CA); Mo-Han Fong, Ottawa (CA); Sophie Vrzic, Nepean (CA); Robert Novak, Ottawa (CA); Jun Yuan, Ottawa (CA)

(72) Inventors: Kelvin Kar-Kin Au, Ottawa (CA); Mo-Han Fong, Ottawa (CA); Sophie Vrzic, Nepean (CA); Robert Novak, Ottawa (CA); Jun Yuan, Ottawa (CA)

(73) Assignee: Research In Motion Limited, Waterloo (CA)

(21) Appl. No.: 13/620,699

(22) Filed: Sep. 14, 2012

Related U.S. Application Data
(63) Continuation of application No. 12/342,757, filed on Dec. 23, 2008.
Application No. 12/342,757 is a continuation of application No. 12/266,983, filed on Nov. 7, 2008, now abandoned.
Application No. 12/266,983 is a continuation-in-part of application No. 12/202,901, filed on Sep. 2, 2008, now abandoned.
(60) Provisional application No. 60/986,808, filed on Nov. 9, 2007.
(60) Provisional application No. 60/969,022, filed on Aug. 30, 2007.

(51) Int. Cl. H04B 7/06; H04W 72/04

(52) U.S. Cl. 370/329; 375/267

(57) ABSTRACT

Methods and apparatus are described for implementing multiple user, multiple input, multiple output (MU-MIMO) communications involving the use of beamforming where signals transmitted from a transmitter are received at multiple receivers. The method includes schemes for the calculation of interference implemented at the transmitting end, and in some embodiments receiving ends, of the channel.

### RELATED APPLICATIONS

The present patent application is a continuation of U.S. patent application Ser. No. 12/266,983 filed on Nov. 7, 2008, which is a continuation in part of U.S. patent application Ser. No. 12/202,901 filed on Sep. 2, 2008, the U.S. patent application Ser. No. 12/266,983 claims the benefit of U.S. Provisional Patent Application Ser. No. 60/986,808, filed on Nov. 9, 2007, U.S. patent application Ser. No. 12/202,901 claims the benefit of U.S. Provisional Patent Application Ser. No. 60/969,022 filed on Aug. 30, 2007, the entire contents of the foregoing applications are incorporated herein by reference.

### FIELD OF THE INVENTION

The present invention relates to systems and methods for Multi-User Multiple Input, Multiple Output communication systems.

### BACKGROUND

Multiple input, multiple output (“MIMO”) systems use a plurality of transmission antennas and a plurality of reception antennas to provide for spatial multiplexing of signals such that signals transmitted via multiple transmission antennas are independent of one another. This may be advantageous, for these transmitted signals are subject to a host of distortions, including shadowing, fading, and multipath interference. Such distortion can impact the amplitude and/or phase of the signal, which can inhibit high-speed data communication.

A multi-user MIMO (MU-MIMO) system may use beamforming to spatially multiplex mobile stations. Beams are formed by a precoder at the transmitter which precodes users' data with different precoder vectors, which are also known as codewords. A precoder vector contains weights on the transmit antennas that linearly combine the transmit data. In a MIMO system, the weights may be obtained from the singular value decomposition (SVD) of the MIMO channel matrix. In a MU-MIMO system that employs Eigen-beamforming, data streams to different users are multiplexed in Eigen-beams on the same time-frequency resource. Multiplexing different users at different time slots may cause intra-cell interference variability, even in a low speed environment.

In any communication system, the quality and capacity of a communication channel are affected by such factors as interference, allocation of communication resources, the communication schemes or algorithms used on the communication channel, and the particular communication equipment implemented at transmitting and receiving ends of the channel. Reliability, throughput, and capacity gain depend on channel quality information, such as the carrier signal to interference ratio (C/I) fed back from mobile stations, used by a base station. In order to fully take advantage of adaptive coding and modulation, the channel quality feedback needs to track the changes in channel condition. With interference variability due to spatial multiplexing, the degradation in link adaptation may severely limit the spectral efficiency of multi-user MIMO. In Eigen-beamforming spatial division multiple access (“SDMA”), multiple users are scheduled on the same time-frequency resource separated by Eigen-beams.

### SUMMARY OF THE INVENTION

In one broad aspect, there is provided in a wireless system including a base station having multiple antennas operable to transmit signals to a plurality of mobile stations, each of said mobile stations having multiple antennas, a method for implementing multiple user, multiple input, multiple output (MU-MIMO) communications, the method comprising: transmitting from the base station at least one precoder vector to at least one mobile station.

In another broad aspect, there is provided a receiver comprising: a processor, and a plurality of antennas connected to the processor, each antenna configured to receive at least one precoder vector from a base station.

In another broad aspect, there is provided a multiple input, multiple output wireless station operable to transmit signals to a subscriber terminal, the wireless station comprising: a signal generator operable to generate a signal having a signal portion indicative of an interfering precoder vector that may affect a subscriber terminal in communication with the wireless station.

Other aspects and features of the present invention will become apparent, to those ordinarily skilled in the art, upon review of the following description of the specific embodiments of the invention.

### BRIEF DESCRIPTION OF THE DRAWINGS

The invention will now be described in greater detail with reference to the accompanying diagrams, in which:

FIG. 1 is a block diagram of a prior art MU-MIMO system.

FIG. 2 is a block diagram of a prior art MU-MIMO system which illustrates inter-user interference.

FIG. 3 illustrates a prior art MU-MIMO system in communication with a mobile station where that mobile station has very limited knowledge of the inter-user interference.

FIG. 4 illustrates a MU-MIMO system in communication with a mobile station according to some embodiments where mobile stations has knowledge of interfering precoder vectors.

FIG. 5 shows MU-MIMO system according to some embodiments involving signalling interfering precoder parameters to at least one mobile station.

FIG. 6A shows a MU-MIMO system according to some embodiments involving defining a number of multiplexed mobile stations.

FIG. 6B shows a defined a number of multiplexed mobile stations over a period of time according to some embodiments.

FIG. 7A shows a MU-MIMO system according to some embodiments involving codebook MU-MIMO.

FIG. 7B is a flowchart of steps in some embodiments of MU-MIMO communication.

FIG. 7C shows interference over a period of time according to some embodiments.

FIG. 8A is a flowchart of steps in some embodiments of MU-MIMO communication.

FIG. 8B is a flowchart of steps in some embodiments of MU-MIMO communication.

FIG. 9 is a flowchart of steps in some embodiments of MU-MIMO communication.

FIG. 10 shows MU-MIMO system according to some embodiments involving multicast communication with mobile stations.

FIG. 11 illustrates a method according to some embodiments where interfering precoder vectors are indicated in a separate field from the message indicating a mobile station's assigned resources.

FIG. 12A illustrates a method according to some embodiments where interfering precoder vectors are indicated in an existing field intended for another purpose or multiple purposes.

FIG. 12B illustrates a method according to some embodiments where interfering precoder vectors are indicated in an existing field intended for another purpose or multiple purposes.

FIG. 13 illustrates a method according to some embodiments where interfering precoder vectors are indicated by the message type.

FIG. 14 illustrates a time-frequency resource zone according to some embodiments where the SDMA zone is defined by the control channel in time/frequency.

FIG. 15 is a flowchart of steps in some embodiments of MU-MIMO communication.

FIG. 16 is a flowchart of steps in some embodiments of MU-MIMO communication.

FIG. 17A illustrates a method according to some embodiments involving dynamic assignment of multiplexed mobile stations to SDMA levels.

FIG. 17B illustrates a method according to some embodiments involving semi-static assignment of multiplexed mobile stations to SDMA levels.

FIG. 17C illustrates a method according to some embodiments involving assignment of multiplexed mobile stations following a hopping pattern.

FIG. 18 is a flowchart of steps in some embodiments of MU-MIMO communication.

FIG. 19 is a flowchart of steps in some embodiments of MU-MIMO communication.

FIG. 20 is a flowchart of steps in some embodiments of MU-MIMO communication.

### DETAILED DESCRIPTION OF THE INVENTION

In a MIMO system, a base station (BS) provides communication services for a coverage area or cell in a wireless communication system. The term “base station” can refer to any access point providing coverage to an area, such as a wireless station. The base station transmits communication signals to mobile stations (MS) via multiple antennas. Mobile stations are also commonly referred to as user terminals, user equipment, subscriber terminals, and communication devices, for instance. The term “mobile station” can refer to any receiving device (stationary or mobile). At a mobile station side, multiple receive antennas are employed for each mobile station.

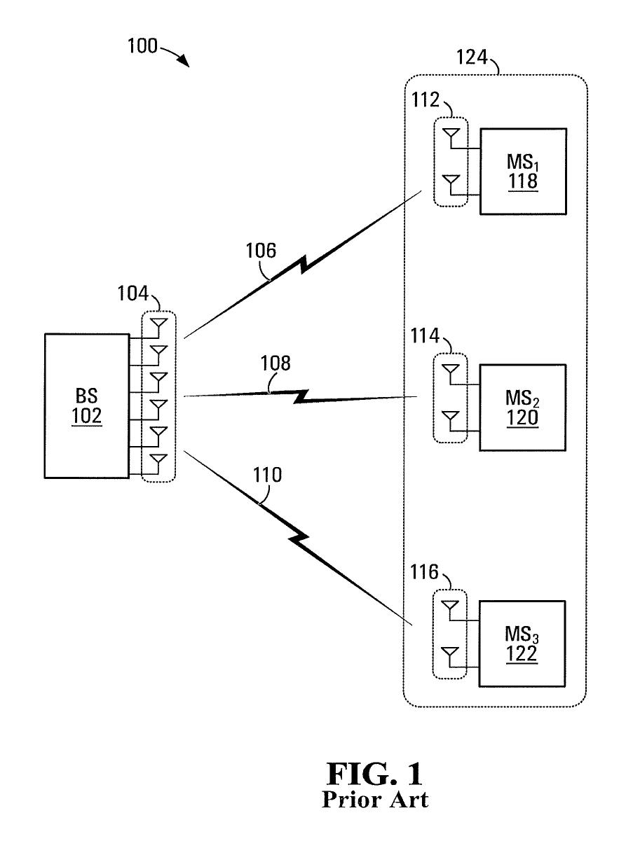

FIG. 1 is a block diagram of a prior art MIMO system 100, which includes a base station 102 having a plurality of antennas 104, a group of mobile stations MS_{N} 124 consisting of MS₁ 118, MS₂ 120, and MS₃ 122, with antenna arrays 112, 114, and 116 respectively, and communications signals 106, 108, and 110. In operation, communication signal 106 is transmitted from the base station 102 via antenna arrays 104 to MS₁ 118, and is received by antenna array 112. Communication signal 108 is transmitted from the base station 102 via antenna arrays 104 to MS₂ 120, and is received by antenna array 114. Communication signal 110 is transmitted from the base station 102 via antenna arrays 104 to MS₃ 122, and is received by antenna array 116.

It should be appreciated that the system of FIG. 1 is intended for illustrative purposes only. As will be apparent to those skilled in the art to which the present invention pertains, base station 102 includes further components in addition to the antenna array 104, such as components to generate the signals 106, 108, and 110 for instance. Similarly, the mobile stations MS₁ 118, MS₂ 120, and MS₃ 122 include components to process received signals, such as a MIMO decoder. Also, the base station 102 and the mobile stations MS₁ 118, MS₂ 120, and MS₃ 122 normally support both transmit and receive operations. It will also be apparent to those skilled in the art that the number of antennas in arrays 104, 112, 114, and 116 may be more or less than that shown in FIG. 1. Finally, it will be apparent to those skilled in the art that the number of mobile stations in group MS_{N} 124 is not restricted to three but may be more or less than three.

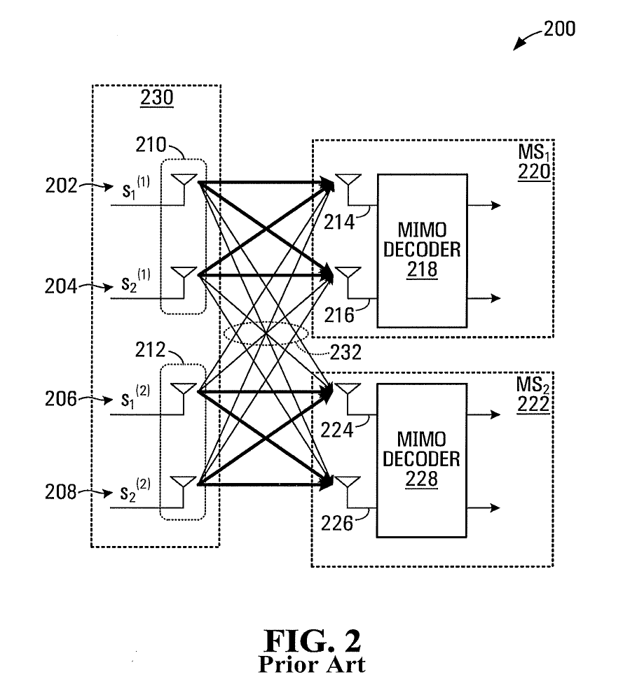

FIG. 2 is a block diagram of a prior art MIMO system 200, and illustrates inter-user interference. FIG. 2 includes four signals 202, 204, 206, and 208 denoted by s₁⁽¹⁾, s₂⁽¹⁾, s₁⁽²⁾, and s₂⁽²⁾ respectively, base station 230 having two pairs of antennas 210 and 212, two mobile stations MS₁ 220 and MS₂ 222, each having two antennas 214/216 and 224/226 respectively and a MIMO decoder 218 and 228 respectively. In operation, the signals 202, 204, 206, and 208, are transmitted from the base station 230 via respective ones of each pair of the antennas 210 and 212 to MS₁ 220 and MS₂ 222. Signals received by the antennas 214/216 and 224/226 in MS₁ 220 and MS₂ 222 are processed by the MIMO decoders 218 and 228. Interference in the MIMO system of FIG. 2 is indicated at 232. As shown, any communication signals that are received at one of the mobile stations MS₁ 220 or MS₂ 222 but intended for the other of the mobile station 220 or 222 represent interference at that mobile station. For example, versions of s₁⁽²⁾ 206 and s₂⁽²⁾ 208 received at MS₁ 220 represent interference. It will be apparent to those skilled in the art that although FIG. 2 only shows two mobile stations MS₁ 220 and MS₂ 222, the number of mobile stations in a MU-MIMO system is not limited to two, and the embodiments described herein may function with different numbers of mobile stations.

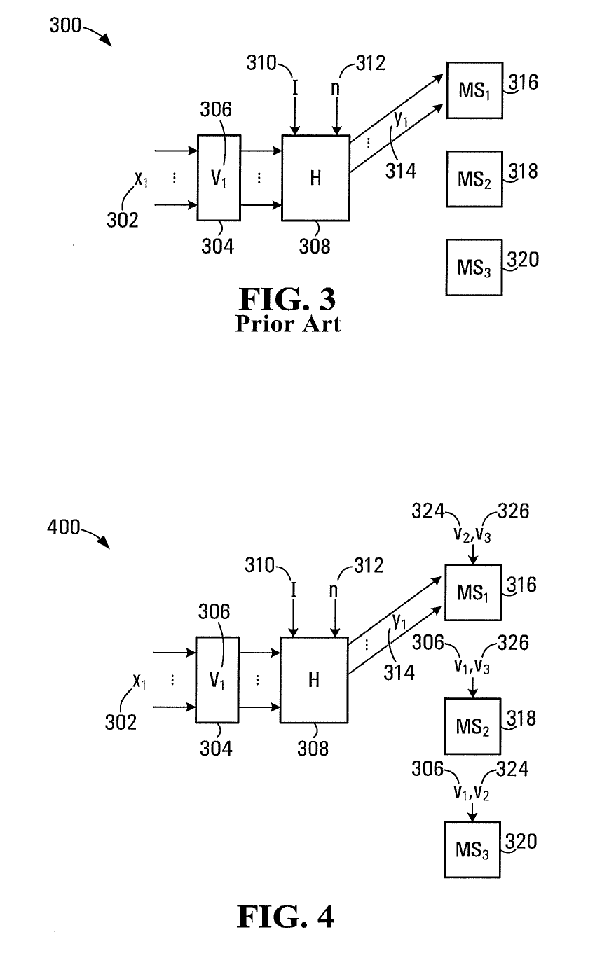

FIG. 3 is a block diagram that illustrates communication with one of a plurality of mobile stations in a prior art MU-MIMO system 300. FIG. 3 shows mobile stations MS₁ 316, MS₂ 318, and MS₃ 320, x₁ which denotes data 302 to be transmitted to MS₁ 316, precoder 304, V₁ which denotes precoder vector 306 to precode data 302 to be transmitted to MS₁ 316, H which denotes MIMO channel matrix 308 between a base station and MS₁ 316, y₁ which denotes received signal 314 of MS₁ 316, I which denotes inter-user interference 310, and “n” which denotes other cell interference and noise 312. In operation, data x₁302 is fed to precoder 304 which precodes the data 302 with precoder vector V₁ 306 for MS₁ 316. The MIMO channel matrix H 308 transforms the precoded signal into received signal y₁314 of MS₁ 316. Inter-user interference I 310 and other cell interference n 312 is added to received signal 314. Therefore, in the multi-user MIMO system of FIG. 3, the received signal 314 of MS₁ 316 can be expressed as:

y+HV₁x₁+I+n (1)

where

I=HV₂x₂+HV₃x₃ (2)

and V₂ to V₃ (not shown) are the precoders used to precode data x₂ and x₃ (not shown) to be transmitted to MS₂ and MS₃.

As will be apparent to those skilled in the art, although not shown in FIG. 3, a base station (not shown) also communicates with MS₂ 318 and MS₃ 320. For communications with MS₂ 318, MS₁ 316 and MS₃ 320 are interfering mobile stations, and for communications with MS₃ 320, MS₁ 316 and MS₂ 318 are interfering mobile stations. It will also be apparent to those skilled in the art that the number of mobile stations in a MU-MIMO system is not limited to three, and the embodiments described herein may function with more or less than three mobile stations.

Currently, the C/I feedback may assume a certain margin that represents the degradation in C/I due to spatial division multiple access (“SDMA”). This results in an unnecessary forfeiture of otherwise available system capacity.

Furthermore, in conventional MU-MIMO systems, a different number of users can be multiplexed at different times. Therefore, the number of mobile stations multiplexed in the current received signal has to be estimated. Since an estimate of interference based on an estimated number of mobile stations can affect the C/I computation which is subsequently fed back to the transmitter for link adaptation, a worst case scenario (e.g., assuming a maximum number of users are multiplexed) is necessarily assumed. As a consequence, an unduly conservative margin can be applied to the C/I, which can compromise network capacity and/or performance. Selecting a conservative modulation and coding scheme (“MCS”) can degrade the overall performance of MU-MIMO.

FIG. 4 is a block diagram that illustrates communication with one of a plurality of mobile stations in a MU-MIMO system 400, according to some embodiments, where the mobile stations have knowledge of the interfering precoder vectors. In FIG. 4, data x₁ 302, precoder 304, precoder vector V₁ 306, MIMO channel matrix H 308, received signal y₁ 314, inter-user interference I 310 and other cell interference and noise 312 operate the same as in FIG. 3. FIG. 4 shows further elements V₂ and V₃ which denote interfering precoder vectors 324 and 326 used to precode data transmitted to MS₂ 318 and MS₃ 320. In operation MS₁ 316 has knowledge of the interfering precoder vectors V₂ 324 and V₃ 326.

As will be apparent to those skilled in the art, MU-MIMO system 400 includes further components in addition to the precoder 304, such as a signal generator operable to generate a signal having a signal portion indicative of precoder vectors. It will also be apparent to those skilled in the art, although not shown in FIG. 4, a base station also communicates with MS₂ 318 and MS₃ 320. Accordingly, MS₂ 318 and MS₃ 320 may have knowledge of respective interfering precoder vectors 306/326 for MS₂ 318 and 306/324 for MS₃, as shown in FIG. 4. As will also be apparent to those skilled in the art, interfering precoder vectors may also arise from mobile stations outside of multiplexed mobile stations MS₁ 316, MS₂ 318, and MS₃ 320, and possibly from a coverage area not serviced by the base station. When a mobile station MS₁ 316, MS₂ 318 or MS₃ 320 obtains knowledge of its respective interfering precoder vectors, C/I may be more accurately estimated for that mobile station. Moreover, the number of users multiplexed in the transmission may be deduced in some embodiments.

A more accurate C/I computation may lead to improved link adaptation performance. For example, in some embodiments, if a minimum mean square error (“MMSE”) receiver is used, the instantaneous receiver weights may be computed as

w=(HH^{H}+Rᵢ)⁻ⁱH (2)

for which R^{H} is the Hermitian transposition of the channel matrix 308. Rᵢ is the instantaneous correlation of the interference 310 plus noise 312. Rᵢ can be estimated more accurately with the knowledge of the interfering precoder vectors. The weights obtained can better suppress the interference 310. In other embodiments, mobile stations MS₁ 316, MS₂ 318 and MS₃ 320 may make use of the knowledge of interfering precoder vectors to perform interference cancellation.

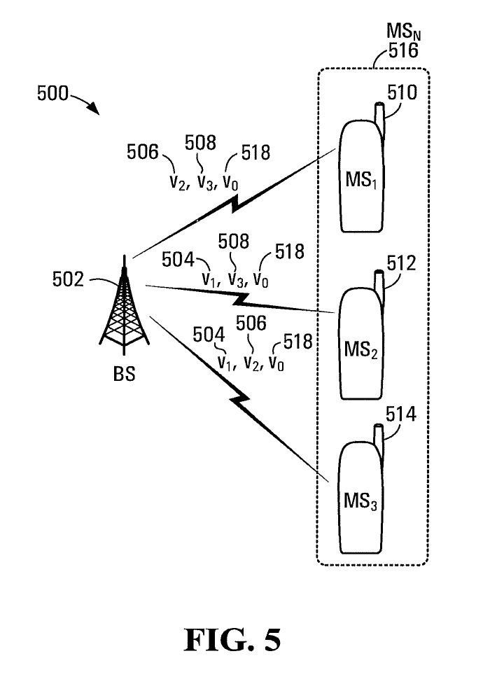

FIG. 5 shows a MU-MIMO communications system 500, according to some embodiments, including a base station 502, a plurality of mobile stations MS_{N} 516 consisting of MS₁ 510, MS₂ 512 and MS₃ 514, and v₁, v₂, v₃, and v₀ which denote precoder parameters 504, 506, 508, and 518 respectively. Precoder parameters v₁ 504, v₂ 506, and v₃ 508 are indicative of precoder vectors V₁, V₂, and V₃ (not shown) used to precode data for transmission to MS₁ 510, MS₂ 512, and MS₃ 514 respectively. Precoder parameters v₀ 518 are indicative of precoder vector(s) arising from mobile station(s) outside of group MS_{N} 516 and possibly from a coverage area not serviced by the base station 502. Precoding parameters 504, 506, 508, and 518 may be the precoder vectors, indices, bitmaps, or other information relating to precoder vectors as discussed in relation to other embodiments. In operation, base station 502 multiplexes mobile stations MS₁ 510, MS₂ 512 and MS₃ 514 using known MIMO or SDMA methods. When communicating with MS₁ 510, base station 502 signals interfering precoder parameters v₂ 506 and v₃ 508 to MS₁ 510. Similarly, for communications with MS₂ 512, V₁ and V₃ are interfering precoder vectors, and for communications with MS₃, V₁ and V₃ are interfering precoder vectors. Therefore parameters v₁ 504 and v₃ 508 are signalled to MS₂ 512 and parameters v₁ 504 and v₂ 506 are signalled to MS₃ 514. The base station 502 may also signal interfering precoder parameters v₀ 518 to the mobile stations MS_{N} 516 as shown. Although FIG. 5 shows group MS_{N} 516 having three mobile stations, N is not restricted to be equal to three. The number of mobile stations in MS_{N} 516 is likewise not restricted in other embodiments to be discussed.

As will be apparent to those skilled in the art, base station 502 includes components such as a signal generator operable to generate a signal having a signal portion indicative of precoder vectors. As will also be apparent to those skilled in the art, it may not be necessary for all mobile stations to have knowledge of interfering precoder vectors as shown in FIG. 5 in order to improve C/I calculation for one or more mobile stations.

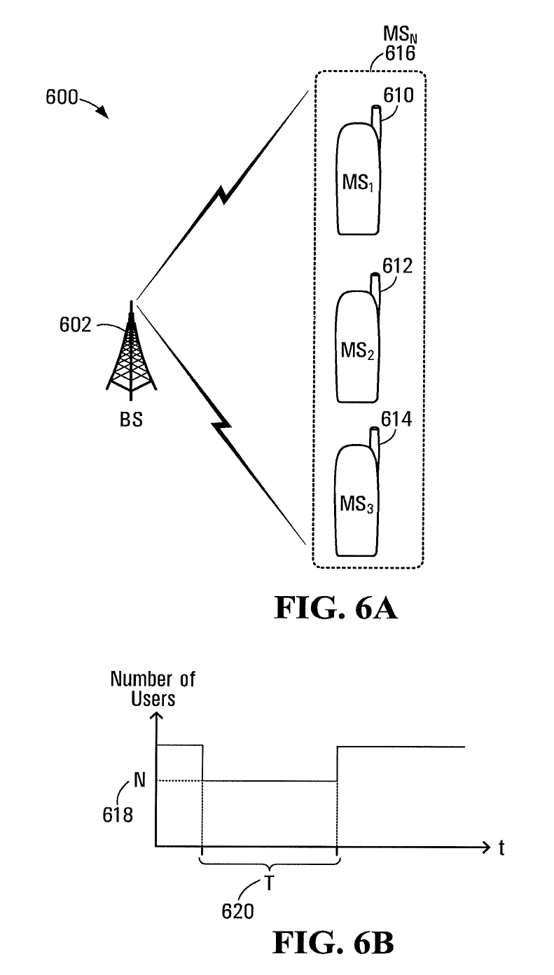

FIG. 6A shows a MU-MIMO system 600 according to some embodiments including a base station 602, a defined group of mobile stations MS_{N}616 consisting of MS₁ 610, MS₂ 612 and MS₃ 614. In operation, base station 602 configures a MU-MIMO zone such that the number of mobile stations in group MS_{N} 616 remains constant over a period of time. In FIG. 6B, N denotes the number 618 of mobile stations in group MS_{N} 616, and T denotes a period of time 620. In operation, N 618 remains constant over T 620. The base station may determine N based on several factors including environment, system capability, etc. Period of time T 620 may be equal to a superframe, so that N 618 is configured every superframe. Mobile stations MS₁ 610, MS₂ 612 and MS₃ 614 can report a more accurate C/I with a constant number N 618 of mobile stations 616 over period of time 620. The number N 618 of mobile stations in Group MS_{N} 616 may be signalled or otherwise determined by mobile stations MS₁ 610, MS₂ 612 and MS₃ 614. Therefore, the worst case scenario (maximum multiplexing of users) may not need to be assumed in C/I estimation.

In codebook based MU-MIMO, sets of predefined precoder vectors are used. These predefined sets of precoder vectors form a codebook. Precoder vectors in the codebook are indexed, and each precoder vector correspond to an index or bitmap value.

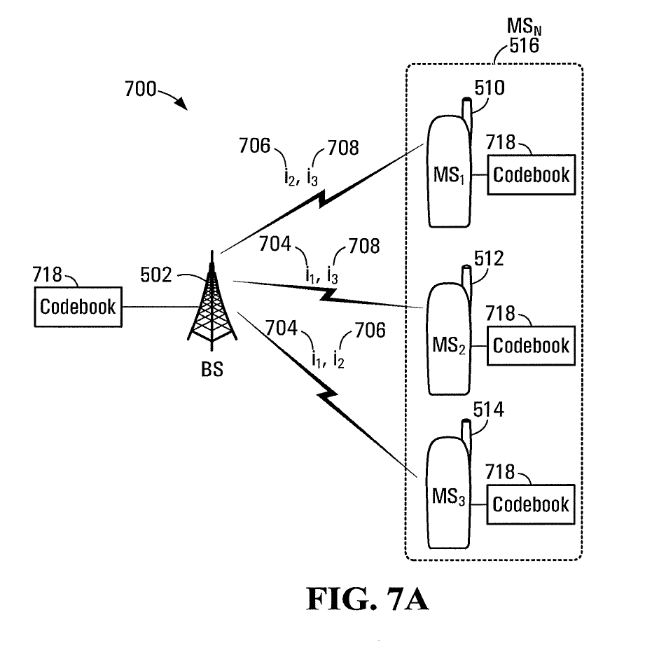

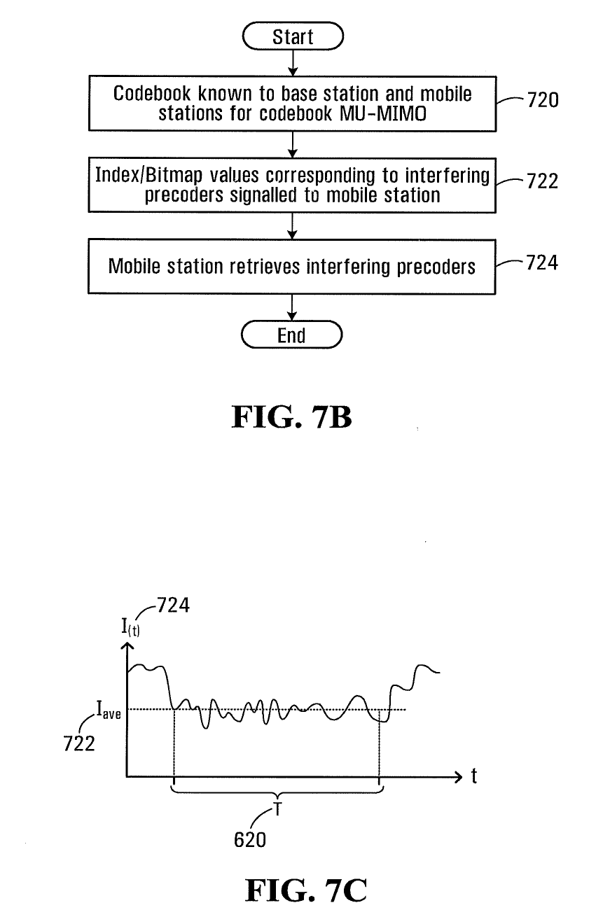

FIG. 7A shows a MU-MIMO system 700 according to some embodiments including a base station 502, a plurality of mobile stations MS_{N} 516 consisting of MS₁ 510, MS₂ 512 and MS₃ 514, codebook 718, and i₁, i₂, and i₃ which denote precoder vector parameters 704, 706, and 708 respectively. The elements of FIG. 7A operate in a similar fashion as those in FIG. 5. In addition, base station 502 and mobile stations 516 store codebook 718. Precoding parameters i₁ 704, i₂ 706 and i₃ 708 are the index or bitmap value of the corresponding precoder vectors V₁, V₂, and V₃ (not shown) which are used to precode data to be transmitted to MS₁ 510, MS₂ 512, and MS₃ 514 respectively, and which are contained in the codebook 718. Base station 502 signals the index i₁ 704, i₂ 706 or i₃ 708 of interfering precoder vectors to mobile stations MS₁ 510, MS₂ 512 or MS₃ 514, and mobile stations MS₁ 510, MS₂ 512 or MS₃ 514 then retrieve interfering precoder vectors from the codebook 718.

FIG. 7B is a flowchart of steps in some embodiments involving involving codebook MU-MIMO as it may be implemented by the elements of FIG. 7A. At step 720, the codebook 718 is known to base station 502 and the mobile stations 516. At step 722, the base station 502 signals index or bitmap values 706/708, 704/708, or 704/706 corresponding to the interfering precoder vectors. At step 724, mobile station MS₁ 510, MS₂ 512, and MS₃ 514 use the index or bitmap values 706/708, 704/708, or 704/706 to retrieve their respective interfering precoder vectors.

Codebook MU-MIMO may or may not be implemented in conjunction with other embodiments described herein. When configuring the number of users in a MU-MIMO system, as shown in FIGS. 6A and 6B, a mobile station MS₁ 510, MS₂ 512, or MS₃ 514 may predict the inter-user interference by averaging the interference caused by using different precoder vectors in the codebook 718. FIG. 7C shows an average inter-user interference Iₐᵥₑ 722, actual interference I(t) 724, and period of time T 620. Interference I(t) 724 varies around the average inter-user interference Iₐᵥₑ 722 over the time period T 620 wherein the number of users in the MU-MIMO system is constant. As explained above, Iₐᵥₑ is the average of interference caused by using different precoder vectors in the codebook. It should be appreciated that FIG. 7C is intended for illustrative purposes only in order to show how average interference may relate to the number of users in a codebook MU-MIMO communication system.

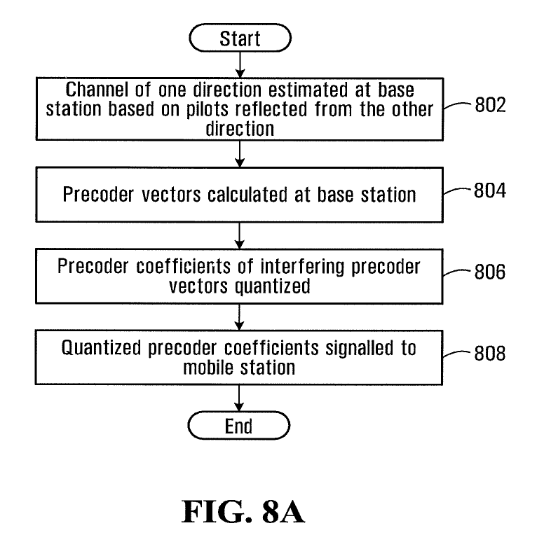

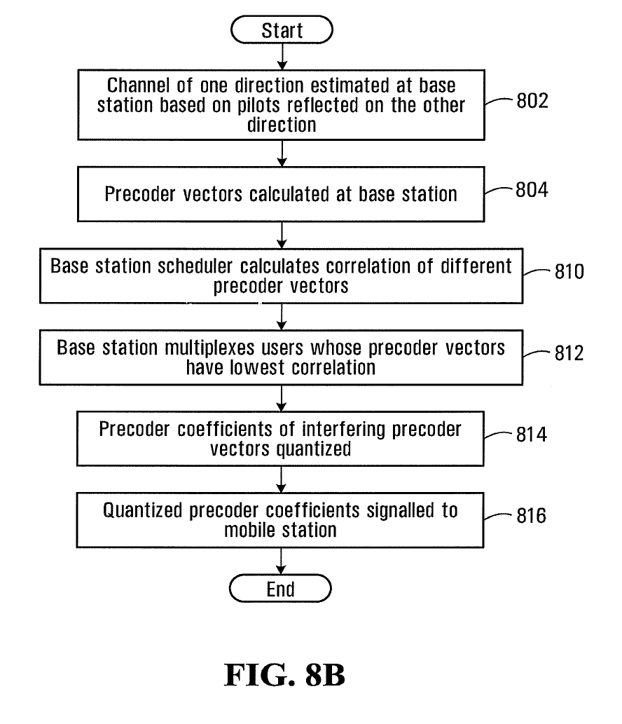

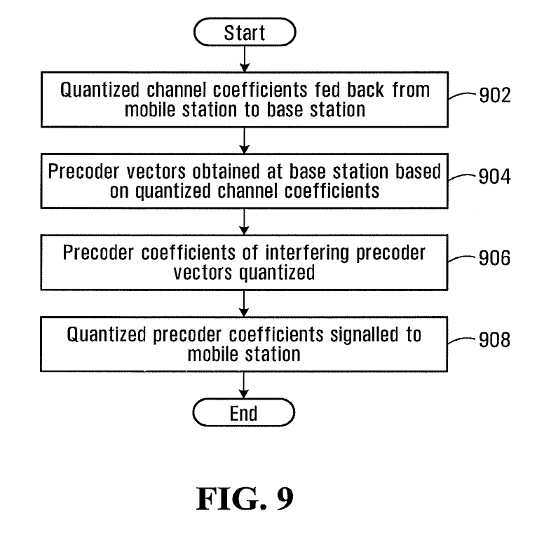

In some embodiments, with reference to the elements of FIG. 5, precoder vectors are computed on the fly by the base station 502 based on the channel state information (CSI) at the base station 502, and the interfering precoder vectors are quantized and signalled to the mobile stations MS₁ 510, MS₂ 512, or MS₃ 514. Since a precoder vector may be obtained by the singular value decomposition of the MIMO channel, the following embodiments shown in FIGS. 8A, 8B, and 9 may be realized.

FIG. 8A is a flowchart of a method for a MU-MIMO system according to some embodiments, with reference to the elements shown in FIG. 5, involving channel sounding. At step 802, the channel in one direction (e.g., the forward link) is estimated at the base station 502 based on pilots transmitted from the other direction (e.g., the reverse link). At step 804, the precoder vectors for mobile stations MS_{N} 516 are calculated at the base station 502. At step 806, the interfering precoder vector coefficients used in the multi-user transmission are quantized. At step 808, quantized precoder coefficients are signalled to the respective mobile stations MS₁ 510, MS₂ 512, or MS₃ 514. In the embodiments shown in FIG. 8A, the quantized precoder coefficients are the interfering precoder parameters 506/508, 504/508, or 504/506 shown in FIG. 5.

FIG. 8B is a flowchart of an example of an embodiment of the method shown in FIG. 8A. Steps 802 and 804 are carried out in the same manner as discussed above in connection with FIG. 8A. At step 810, a base station scheduler may calculate the correlation of different precoder vectors and, at step 812, multiplex mobile stations MS₁ 510, MS₂ 512, or MS₃ 514, whose precoder vectors have the lowest correlation to minimize the inter-user interference. At step 814, the interfering precoder vector coefficients used in the multi-user transmission are quantized. At step 816, quantized precoder coefficients are signalled to the respective mobile stations MS₁ 510, MS₂ 512, or MS₃ 514. In the embodiments shown in FIG. 8A, the quantized precoder coefficients are the interfering precoder parameters 506/508, 504/508, or 504/506 shown in FIG. 5.

FIG. 9 is a flowchart of a method for a MU-MIMO system according to some embodiments, with reference to the elements shown in FIG. 5, involving calculating precoder vectors based on quantized channel coefficients. At step 902, quantized channel coefficients are fed back from mobile stations MS_{N} 516 to the base station 502. Similar to channel sounding, at step 904, the precoder vectors are obtained at the base station 502 based on the quantized channel coefficients. At step 906, the interfering precoder vector coefficients used in the multi-user transmission are quantized. At step 908, the quantized precoder coefficients are signalled to the mobile stations MS₁ 510, MS₂ 512, or MS₃ 514. In the embodiments shown in FIG. 9, the quantized precoder coefficients are the interfering precoder parameters 506/508, 504/508, or 504/506 shown in FIG. 5.

In some embodiments, the signalling of interfering precoder parameters to mobile stations can be purely unicast. FIG. 5 illustrates unicast signalling of the interfering precoder parameters 506/508, 504/508, or 504/506 and possibly 518 to the respective mobile station MS₁ 510, MS₂ 512, or MS₃ 514. Unicast signalling may be beneficial if the multiplexed mobile stations are in very different geometry. In this manner, the unicast signalling can be adapted by power control or resource assignment to geometry, or channel conditions, of each mobile station MS₁ 510, MS₂ 512, or MS₃ 514 independently.

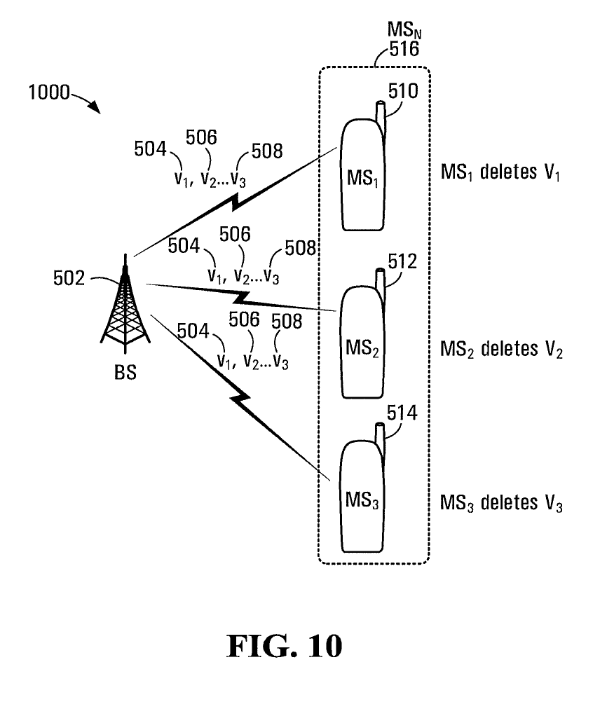

FIG. 10 illustrates MU-MIMO system 1000 in which precoding parameters are signalled in a multicast fashion. FIG. 10 shows a base station 502, a group of mobile stations MS_{N} 516 which consists of mobile stations MS₁ 510 MS₂ 512, and MS₃ 514, and v₁, v₂, and v₃ which denote precoder parameters 504, 506, and 508. Precoder parameters v₁ 504, v₂ 506, and v₃ 508 are indicative of precoder vectors V₁, V₂, and V₃ (not shown) used to precode data for transmission to MS₁ 510, MS₂ 512, and MS₃ 514 respectively. In operation, the base station 502 signals all or part of the precoder information 504, 506, and 508 to all of the spatially multiplexed mobile stations 516. Each SDMA mobile station 516 determines the interfering precoder vectors in the set by deleting its own precoder from the set. Multicast signalling may be beneficial if the multiplexed mobile stations 516 are in similar geometery. In this manner, the multicast message is received by several mobile stations 516 preventing the need for several unicast messages, and hence, reducing signalling resources. Multicast signalling may save on overhead bandwidth and may avoid the need of duplicating information. Although other embodiments described herein have been described with reference to a unicast system, a multicast system may also be used in conjunction with other embodiments of the invention.

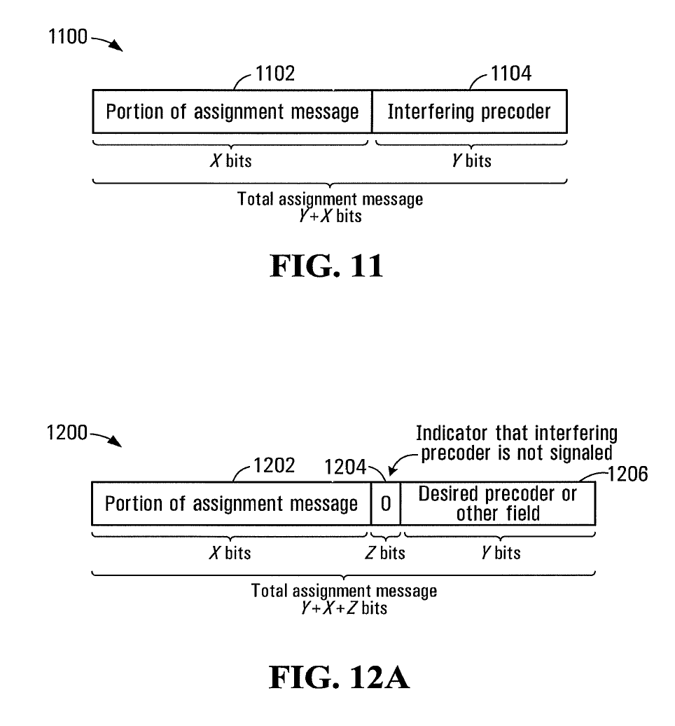

In some embodiments, the interfering precoder parameters may be signalled (i.e., indicated) to mobile stations via the message indicating the station's assigned resources. FIGS. 11 to 13 provide detail regarding how a base station may signal interfering precoder parameters to mobile stations. FIG. 11 shows a total assignment message 1100 consisting of a portion of the assignment message 1102 and a separate field 1104. In operation, interfering precoder parameters are indicated in the separate field 1104 indicating the interfering precoder parameters to the mobile station.

In other embodiments, interfering precoder parameters may be indicated in an existing field intended for another purpose or multiple purposes.

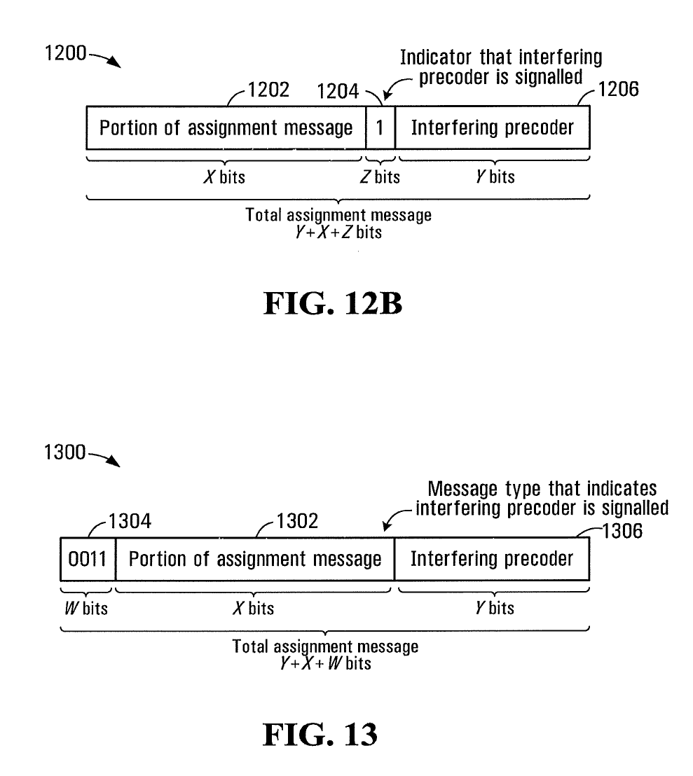

In some cases, a mobile station may be notified that a field now contains the interfering precoder parameter(s) by a bit indicator in the message, such as illustrated in FIGS. 12A and 12B. FIGS. 12A and 12B show a total assignment message 1200 consisting of a portion of the assignment message 1202, an indicator bit 1204, and a desired precoder parameter field or other field 1206. In operation, the indicator bit 1204 indicates whether or not an interfering precoder parameter is being signalled in the existing field 1206. The indicator bit 1204 in FIG. 12A indicates that an interfering precoder parameter is not signalled. In FIG. 12B, the indicator bit 1204 shows that an interfering precoder parameter is signalled and is then followed by the interfering precoder parameter. The interfering precoder parameter may simply be an interfering precoder vector's index, such as in codebook MU-MIMO, and more than one interfering precoder parameter can be indicated.

Alternatively, a mobile station may be notified that a field now contains interfering precoder parameter(s) by the assignment message type. FIG. 13 shows a total assignment message 1300 consisting of a message type indicator 1304, a portion of the assignment message 1302, and an interfering precoder parameter field 1306. In FIG. 13, the message type indicator 1304 indicates that the interfering precoder parameter(s) is signalled.

Multi-user MIMO and single-user MIMO can be switched dynamically based on many factors such as user channel conditions, quality of service (“QoS”) etc. In the dynamic case, at any given time and/or time-frequency resource, users may or may not be multiplexed. Another way is to define a zone in time or time-frequency resource whereby transmissions can be restricted to SDMA.

An SDMA zone is a defined time-frequency region that may be used for the purpose of MU-MIMO transmissions. For the purpose of MU-MIMO transmissions, an SDMA zone may also be referred to as a MU-MIMO zone. The region can consist of one or more logical channels. The logical channels may or may not be physically contiguous. MU-MIMO assignments can be made in this resource space. In some cases, within this zone certain rules can be defined to facilitate operation for either the base station, or for the mobile station, or both.

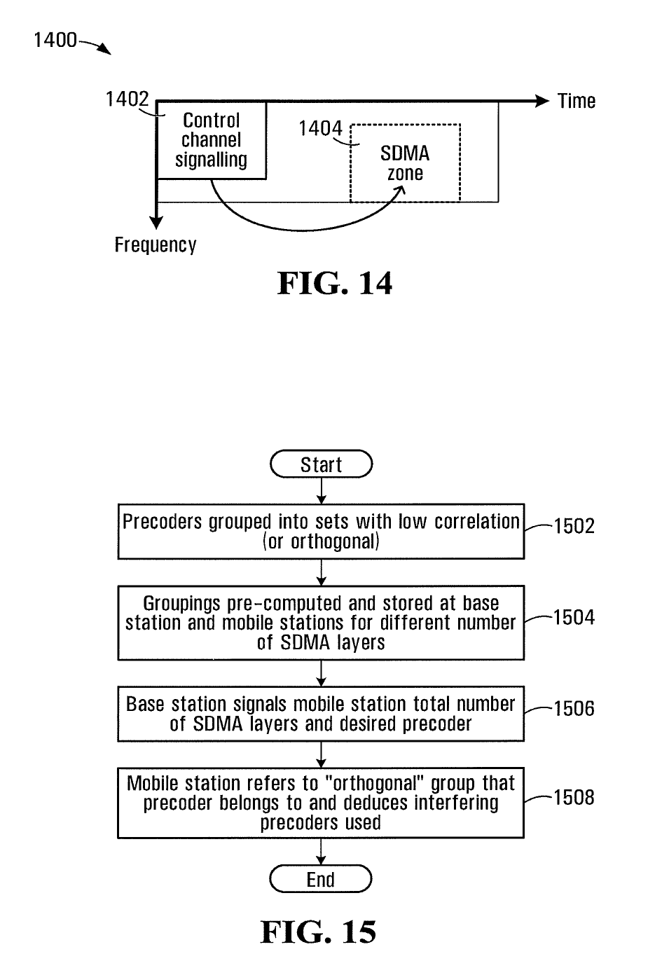

FIG. 14 shows a time-frequency resource zone 1400 according to some embodiments including an SDMA zone 1404 and a control channel signalling zone 1402. In operation, SDMA zone 1404 is defined by control channel signalling zone 1402 in time/frequency. The defined SDMA zone 1404 may include rules or constraints as described below. In FIG. 14, the control channel signalling zone 1402 is not part of the SDMA zone 1404. SDMA zone 1404 may also be referred to as a MU-MIMO zone.

The signalling requirement for the dynamic and non-dynamic cases may be different. In the dynamic case, since mobile stations do not know whether they will be receiving data in SDMA or not, they most likely will report all their preferred precoder vectors. Therefore, a base station needs to signal to a user if only a subset of their preferred precoder vectors is used due to SDMA, in additional to the interfering precoder vectors.

On the other hand, if it is known beforehand, via initial configuration or upper layer signalling, that an SDMA zone 1404 exists, as shown in FIG. 14, certain rules, constraints, or zone parameters can be defined such as the maximum number of precoder vectors to report per user, or a fixed number of multiplexed mobile stations. For example, in order to multiplex more users, it can be configured that only one precoder per user is reported in the SDMA zone 1404. In this case, the base station may only need to signal the interfering precoder vectors to the users. The desired precoder may not need to be signalled if dedicated pilots are used or if a timing relationship exists between feedback and transmission. Specifically, a mobile station can assume that if a precoded transmission is received, the precoder used is based on the precoder reported a certain number of slots before. Defining the SDMA zone in this way may be useful in non-dynamic switching.

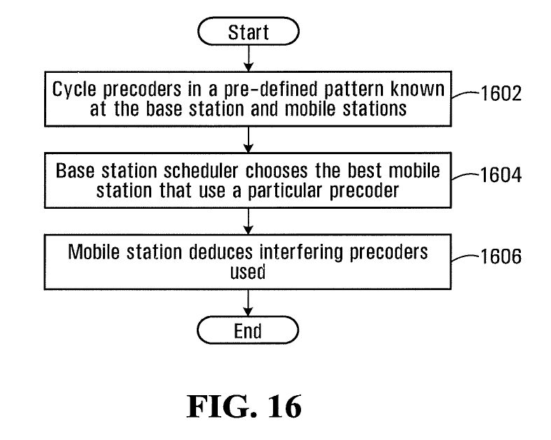

In some embodiments, interfering precoder vectors may be determined by mobile stations automatically without the base station explicitly signalling precoder parameters to the mobile stations as shown in FIGS. 15 and 16.

FIG. 15 is a flowchart of steps in some embodiments, involving mobile stations determining interfering precoder vectors respectively. At step 1502, precoder vectors are grouped into sets with low correlation or into orthogonal sets. At step 1504, this grouping is pre-computed and stored at the base station and mobile stations for different numbers of SDMA layers. Each multiplexed transmission data stream constitutes an SDMA layer. SDMA layers are transmission channels occupying the same time-frequency resources that can be separated using spatial techniques. At step 1506, the base station signals mobile station(s) the total number of SDMA layers and a respective desired precoder. At step 1508, the mobile station(s) refers to the orthogonal, or low correlation, group that its precoder belongs to and deduces its respective interfering precoder vectors. This is because, apart from the desired precoder, the other precoder vectors used for a certain number of SMDA layers are the interference. The total number of SDMA layers may not need to be signalled in every MU-MIMO transmission if the number of layers is configured every time T 620 as shown in FIGS. 6A and 6B, and as explained above. For example, the base station may signal to mobile station(s) the total number of SDMA layers and the desired precoder only one time per superframe.

In another embodiment, the precoder vectors can be cycled in a pre-defined pattern. FIG. 16 is a flowchart showing steps in some embodiments involving determining interfering precoder vectors when precoder vectors are cycled in a predefined pattern. At step 1602, the precoder vectors are cycled in a pre-defined pattern known to a base station and mobile stations. At step 1604, the base station chooses the best mobile station(s) to use a particular precoder. At step 1606, with the knowledge of which layer the mobile station(s) is scheduled on, both the interfering precoder vectors and the desired precoder vectors are deduced by the mobile station(s).

In some further embodiments, a large number of assignments of resources over which data is transmitted may be needed for multi-user and single-user MIMO. For example, VoIP or gaming users may take advantage of the parallel transmissions offered by MIMO.

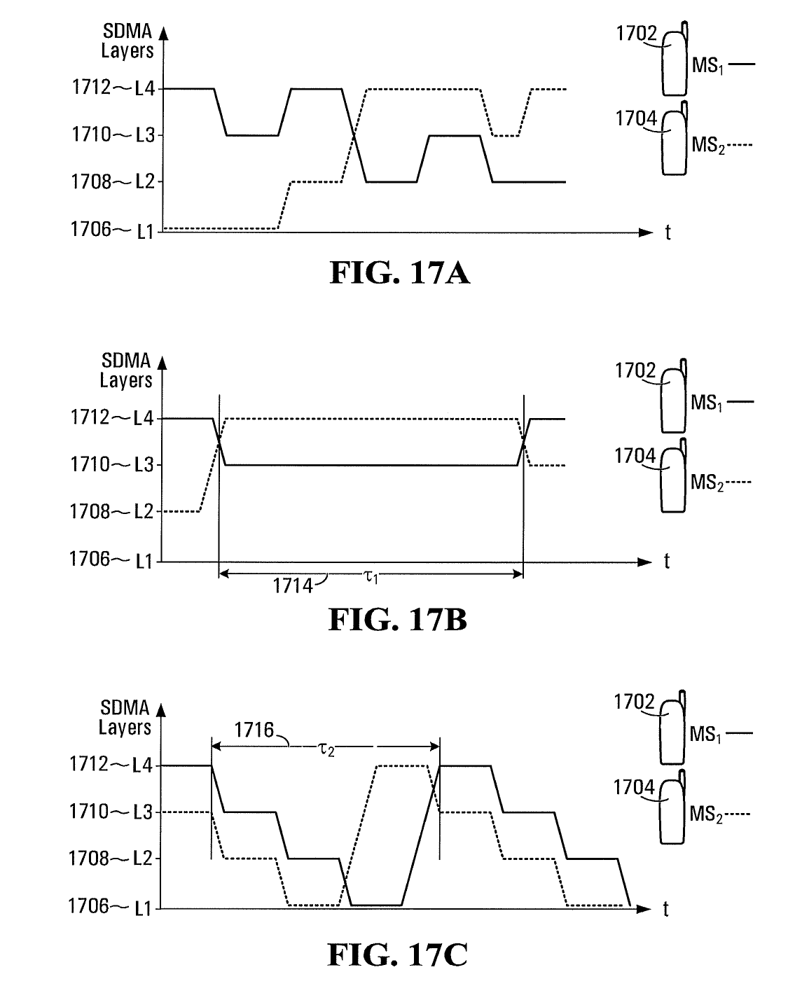

When multiplexing users on different layers, the assignment may be dynamic or semi-static. FIGS. 17A, 17B, and 17C show two mobile stations 1702 and 1704 and SDMA layers L1 1706, L2 1708, L3 1710, and L4 1712, periods of time ι₁ 1714 and ι₂ 1716. In operation, mobile stations 1702 and 1704 are assigned to SDMA layer(s) L1 1706, L2 1708, L3 1710, or L4 1712. In the dynamic case, as shown in FIG. 17A, different mobile stations 1702 and 1704 may be scheduled on different layers L1 1706, L2 1708, L3 1710, or L4 1712 over time. In the semi-static case, as shown in FIG. 17B, mobile stations 1702 and 1704 occupy the same layer(s) L1 1706, L2 1708, L3 1710, or L4 1712 for a period of time ι₁ 1714. The signalling overhead for the semi-static case may thus be reduced. In some embodiments, assignment of mobile stations 1702 and 1704 to SDMA layers L1 1706, L2 1708, L3 1710, or L4 1712 may follow a hopping pattern known to a base station and the mobile stations 1702 and 1704. FIG. 17C shows an example of mobile stations 1702 and 1704 being assigned to SDMA layers L1 1706, L2 1708, L3 1710, or L4 1712 following a hopping pattern with a pattern duration of ι₂ 1716. In this manner, the mobile stations 1702 and 1704 may occupy each layer L1 1706, L2 1708, L3 1710, and L4 1712 for some time for diversity, and may require no additional signalling. As with other embodiments described herein, it should be appreciated that FIGS. 17A, 17B, and 17C are intended for illustrative purposes only. As will be apparent to those skilled in the art to which the present invention pertains, the number of mobile stations 1702 and 1704 is not restricted to two. SDMA layers L1 1706, L2 1708, L3 1710, and L4 1712 are illustrative examples and do not restrict the number of layers, or the type of assignments to SDMA layers that may be made in accordance with some embodiments.

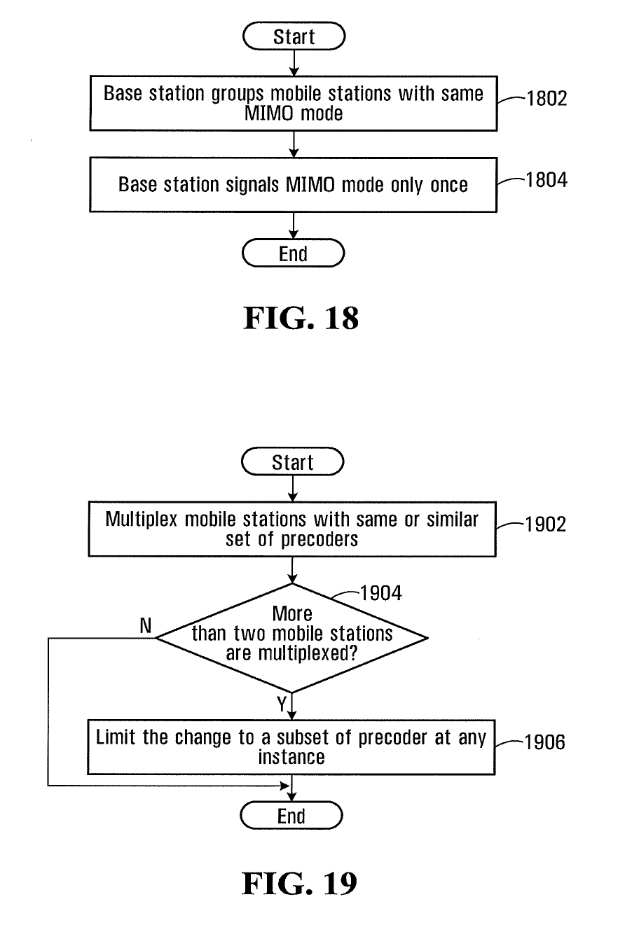

FIG. 18 is a flowchart showing steps in some embodiments, involving grouping mobile stations according to MIMO mode. At step 1802, a base station groups mobile stations with the same MIMO mode. At step 1804, the base station signals the MIMO mode only once per scheduling event rather than once per mobile station. Grouping mobile stations according to MIMO mode may lead to further reduction of the signalling with large numbers of mobile stations.

In order to reduce the potentially large signalling overhead, a bitmap-like signalling structure can be used to signal MSs, and signal the MIMO modes (e.g., spatial multiplexing, STTD, etc.)either by indicating at least one MIMO mode in the bitmap signalling, or by associating a bitmap with a MIMO mode for a period of time. Suitable examples for such signalling are described in, but not limited to, the signalling methods published as international patent application WO 2007/045101 published Apr. 26, 2007 and entitled “Multiplexing Schemes for OFDMA” owned by Nortel Networks Limited, the assignee of the subject application (Attorney Docket No. 18022ROWO04W). A bitmap is a set of bits, where the position and value of each bit is significant. For example, a different mobile station may be assigned to each bit position and the value of the bit may indicate whether or not the mobile station has been assigned a resource. In some cases, further reduction of signalling the MIMO mode may also be possible. The bitmap signalling approach may work well in conjunction with MIMO mode grouping shown in FIG. 18. For example, it is usually the case that a number of assignments use the same MIMO mode. Therefore, the MIMO mode can be signalled only once for the group of assignments.

With a more accurate C/I estimation based on the information of multi-user interference, a base station may also multiplex mobile stations intelligently to reduce the interference variability of subsequent transmissions. FIG. 19 is a flowchart showing steps in some embodiments involving intelligent multiplexing. At step 1902, mobile stations with the same or similar set of precoder vectors are multiplexed. At step 1904, if more than two mobile stations are multiplexed (and thus more than two precoder vectors are used), proceed to step 1906. At step 1906, the change in scheduled mobiles (or precoder vectors) is limited to a subset of precoders used in each scheduling interval at any instance such that the interference can be somewhat regulated. Limiting the subset of precoders in this manner may minimize the changes in the interference variability.

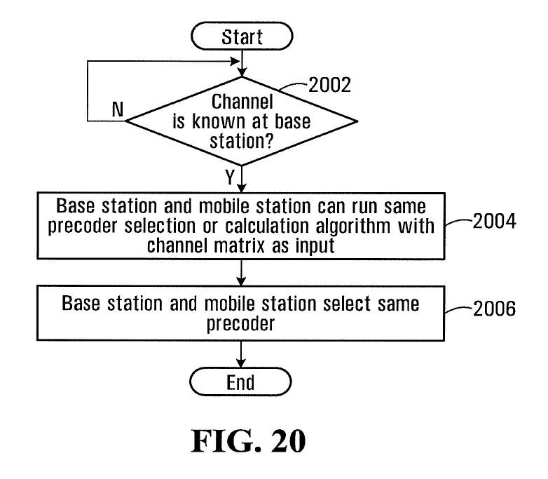

If the channel is known at a base station, for example, using the channel sounding method, it is possible that the desired precoder needs not be signalled. FIG. 20 is a flowchart showing steps in some embodiments when the channel may be known. At step 2002, if the channel is known at the base station, then proceed to step 2004. At step 2004, a base station and mobile station run the same precoder selection or calculation algorithm with the channel matrix as an input. The selected precoder can then be known automatically at both the base station and mobile station.

In some cases, where the base station signals the interfering precoder vectors, the base station may not need to signal the selected precoder using the above method(s), and may signal the interfering precoder vectors used by the interfering mobile stations to a mobile station.

While Eigen beamforming has been primarily considered here, techniques and methods described are applicable to other beamforming techniques including systems with array beamforming, fixed beamforming, or those using angle of arrival. For example, in fixed beamforming systems, the mobile station can be notified of the interfering beamforming vectors' indices rather than precoder vectors.

While the invention has been shown and described with reference to certain preferred embodiments, it is to be understood and appreciated by those skilled in the art that various changes in form and detail may be made herein without departing from the scope and spirit of the invention as defined by the appended claims.

What has been described is merely illustrative of the application of the principles of the invention. Other arrangements and methods can be implemented by those skilled in the art without departing from the spirit and scope of the present invention.

1. A base station for use in a wireless system including a plurality of mobile stations, each of said mobile stations having multiple antennas, the base station comprising:
a plurality of antennas configured to transmit signals to a plurality of mobile stations; and
a processor configured to implement multiple user, multiple input, multiple output (MU-MIMO) communications by transmitting at least one precoder vector to at least one mobile station.

2. The base station of claim 1, wherein the at least one precoder vector is an interfering precoder vector.

3. The base station of claim 1, wherein the processor is further configured to transmit the at least one precoder vector to at least one other mobile station.

4. The base station of claim 1, wherein the processor is further configured to configure a number of mobile stations in the wireless system such that the number of mobile stations remains constant over a predetermined period of time.

5. The base station of claim 1, wherein the processor is further configured to transmit the at least one precoder vector in the form of one of:
a message including information regarding assigned resources of the at least one mobile station; or
a field separate from the message including information regarding assigned resources of the at least one mobile station.

6. The base station of claim 1, wherein one of a SDMA (Spatial Division Multiple Access) zone and a MU-MIMO zone is defined between the base station and the plurality of mobile stations, and at least one zone parameter is configured to control at least one of:
a number of the plurality of mobile stations;
selection of precoder vectors; or
transmission of precoder vectors.

7. The base station of claim 1, wherein the processor is further configured to:
group precoder vectors into sets;
transmit a total number of SDMA layers to the at least one mobile station; and
transmit information regarding said sets to the plurality of mobile stations prior to transmitting the total number of SDMA layers.

8. The base station of claim 1, wherein precoder vectors are cycled in a pattern known to the plurality of mobile stations and the base station.

9. The base station of claim 1, wherein the processor is further configured to:
at least one of:
schedule the at least one mobile station with a MIMO layer or precoder assignment dynamically; or
schedule the at least one mobile station with a MIMO layer or precoder assignment semi-statically.

10. The base station of claim 1, wherein the processor is further configured to schedule the at least one mobile station in a hopping pattern over MIMO layers or precoder vectors.

11. The base station of claim 1, wherein the processor is further configured to group at least one of the plurality of mobile stations according to at least one MIMO mode.

12. The base station of claim 11, wherein the processor is further configured to transmit at least one bitmap signalling structure that assigns at least one MIMO mode to the at least one mobile station by one of indicating at least one MIMO mode in the bitmap signalling, or by associating a bitmap with a MIMO mode for a period of time.

13. The base station of claim 1, wherein the processor is further configured to transmit the at least one precoder vector by transmitting at least one of an index and bitmap values corresponding to at least one precoder vector selected from a codebook.

14. The base station of claim 13, wherein the processor is further configured to configure a number of mobile stations in the wireless system such that the number of mobile stations remains constant over a predetermined period of time, the at least one mobile station predicting inter-user interference by averaging interference caused by using different precoder vectors in the codebook.

15. A method for use in a receiver having a plurality of antennas, the method comprising:
receiving at each antenna at least one precoder vector from a base station.

16. The method of claim 15, further comprising:
receiving at each antenna one or more precoder vectors in addition to the at least one precoder vector, wherein the at least one precoder vector is an interfering precoder vector.

17. The method of claim 15, further comprising:
receiving at one or more of the plurality of antennas one of index and bitmap values corresponding to at least one precoder vector selected from a codebook stored at the base station.
